(19) United States
(12) Patent Application Publication
(10) Pub. No.: US 2021/0224963 A1
(43) Pub. Date: Jul. 22, 2021

(54) INFORMATION PROCESSING APPARATUS, INFORMATION PROCESSING METHOD, IMAGE PROCESSING APPARATUS, IMAGE PROCESSING METHOD, AND PROGRAM

(71) Applicant: SONY CORPORATION, Tokyo (JP)

(72) Inventors: Kouichi UCHIMURA, Kanagawa (JP); Kuniaki TAKAHASHI, Tokyo (JP)

(73) Assignee: SONY CORPORATION, Tokyo (JP)

(21) Appl. No.: 17/049,203

(22) PCT Filed: Apr. 12, 2019
(86) PCT No.: PCT/JP2019/015902

§ 371 Date: Oct. 20, 2020

(30) Foreign Application Priority Data
Apr. 27, 2018 (JP) 2018-087390

(51) Int. Cl. G06T 5/00; H04N 5/57; A63F 13/52

(52) U.S. Cl. CPC G06T 5/009; H04N 5/57; G06T 2207/20208; G06T 2207/10016; A63F 13/52

(57) ABSTRACT

There is provided an information processing apparatus, an information processing method, an image processing apparatus, an image processing method, and a program that make it possible to perform luminance adjustment on a higher luminance side and a lower luminance side appropriately. The information processing apparatus of one aspect of the present technology adds, to each of pictures for which luminance adjustment is to be performed by a display apparatus, metadata representative of a feature of a luminance and including information representative of a first knee point and information representative of a second knee point on a lower luminance side than the first knee point, and outputs each of the pictures to which the metadata is added to the display apparatus. The present technology can be applied to a game machine ready for outputting of HDR video.

### TECHNICAL FIELD

The present technology relates to an information processing apparatus, an information processing method, an image processing apparatus, an image processing method, and a program, and particularly to an information processing apparatus, an information processing method, an image processing apparatus, an image processing method, and a program that make it possible to perform luminance adjustment on a higher luminance side and a lower luminance side appropriately.

### BACKGROUND ART

In recent years, the number of games for which the HDR (High Dynamic Range) video in which the dynamic range is expanded is used is increasing. While the highest luminance of the SDR (Standard Dynamic Range) video is 100 nit (100 cd/m²), the highest luminance of the HDR video is, for example, 10000 nit exceeding the highest luminance of the SDR video.

The user can enjoy a game in which an image having a wide dynamic range of the luminance is used, by connecting a TV ready for displaying of HDR video to a game machine.

### CITATION LIST

### Patent Literature

### [PTL 1]

JP 2017-169075A

### SUMMARY

### Technical Problem

Even if TVs are ready for displaying of HDR video, in the case where they are different in performance of the display, the appearance of an image differs among the TVs connected to a game machine.

The present technology has been made in view of such a situation as described above and makes it possible to perform luminance adjustment on a higher luminance side and a lower luminance side appropriately.

### Solution to Problem

An information processing apparatus according to a first aspect of the present technology includes a metadata generation section configured to generate metadata representative of a feature of a luminance of each picture, the metadata including information representative of a first knee point and information representative of a second knee point on a lower luminance side than the first knee point, and a software generation section configured to generate software including the metadata to be used in luminance adjustment of the picture.

An image processing apparatus according to a second aspect of the present technology includes a communication section configured to receive pictures outputted from an information processing apparatus and metadata added to each of the pictures and representative of a feature of a luminance, the metadata including information representative of a first knee point and information representative of a second knee point on a lower luminance side than the first knee point, and a signal processing section configured to adjust the luminance of the picture on the basis of the metadata.

An information processing apparatus according to a third aspect of the present technology includes an output controlling section configured to add, to each of pictures for which luminance adjustment is to be performed by a display apparatus, metadata representative of a feature of a luminance and including information representative of a first knee point and information representative of a second knee point on a lower luminance side than the first knee point, and output each of the pictures to which the metadata is added to the display apparatus.

In the first aspect of the present technology, metadata that includes information representative of a first knee point and information representative of a second knee point on the lower luminance side than that of the first knee point and represents a feature of the luminance of each picture is generated, and software including the metadata to be used for luminance adjustment of the picture is generated.

In the second aspect of the present technology, pictures outputted from the information processing apparatus and metadata that is added to each picture, includes information representative of a first knee point and information representing a second knee point on the lower luminance side than that of the first knee point, and represents a feature of the luminance are received, and the luminance of each of the pictures is adjusted on the basis of the metadata.

In the third aspect of the present technology, to each of pictures for which luminance adjustment is to be performed by a display apparatus, metadata that includes information representing a first knee point and information representing a second knee point on the lower luminance side than that of the first knee point and represents a feature of the luminance is added, and each of the pictures to which the metadata is added are outputted to the display apparatus.

### Advantageous Effect of Invention

With the present technology, luminance adjustment on a higher luminance side and a lower luminance side can be performed appropriately.

It is to be noted that the effect described here is not always restrictive, and some other effect described in the present disclosure may be applicable.

### BRIEF DESCRIPTION OF DRAWINGS

FIG. 1 is a view depicting an example of a configuration of an information processing system according to an embodiment of the present technology.

FIG. 2 is a view depicting an example of luminance adjustment.

FIG. 3 is a view depicting an example of a tone curve to be used for luminance adjustment.

FIG. 4 is a view depicting an example of transmission of Dynamic metadata.

FIG. 5 is a view depicting syntax of Dynamic metadata.

FIG. 6 is a view depicting an example of a knee point represented by game metadata.

FIG. 7 is a view depicting a shoulder point and a toe point.

FIG. 8 is a view depicting a first example of syntax of game metadata.

FIG. 9 is a view depicting a second example of the syntax of game metadata.

FIG. 10 is a view depicting a third example of the syntax of game metadata.

FIG. 11 is a view depicting a first one of a fourth example of the syntax of game metadata.

FIG. 12 is a view depicting a particular example of Distribution max rgb percentages and Distribution max rgb percentiles.

FIG. 13 is a view depicting an example of a determination method of a toe point.

FIG. 14 is a view depicting a second one of the fourth example of the syntax of game metadata.

FIG. 15 is a view depicting another particular example of Distribution max rgb percentages and Distribution max rgb percentiles.

FIG. 16 is a view depicting a further particular example of Distribution max rgb percentages and Distribution max rgb percentiles.

FIG. 17 is a view depicting a fifth example of the syntax of game metadata.

FIG. 18 is a view depicting a sixth example of the syntax of game metadata.

FIG. 19 is a block diagram depicting an example of a configuration of a game machine.

FIG. 20 is a block diagram depicting an example of a functional configuration of a controller.

FIG. 21 is a block diagram depicting an example of a configuration of a TV.

FIG. 22 is a flow chart illustrating processing of a game machine.

FIG. 23 is a flow chart illustrating processing of a TV.

FIG. 24 is a block diagram depicting an example of a configuration of a computer.

### DESCRIPTION OF EMBODIMENT

In the following, a mode for carrying out the present technology is described. The description is given in the following order.

1. Luminance Adjustment of HDR Video

2. Example 1 of Descriptions of Game Metadata

3. Example 2 of Descriptions of Game Metadata

4. Example 3 of Descriptions of Game Metadata

5. Example 4 of Descriptions of Game Metadata

6. Example 5 of Descriptions of Game Metadata

7. Example 6 of Descriptions of Game Metadata

8. Configuration and Operation of Individual Apparatus

9. Generation Side of Game Software

10. Other Examples

### <<Luminance Adjustment of HDR Video>

### <Configuration of Information Processing System>

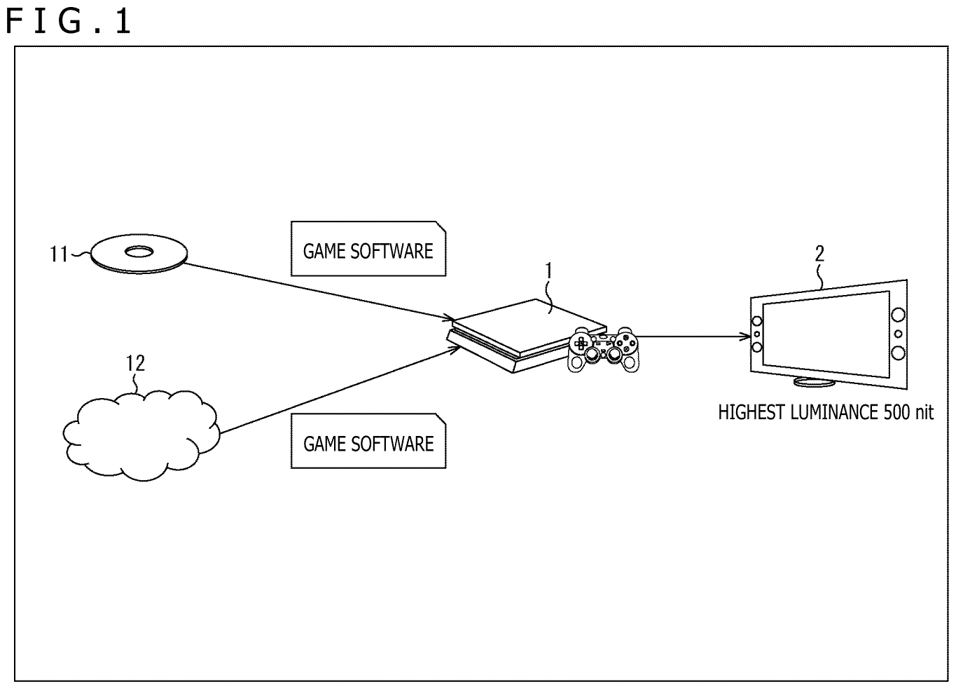

FIG. 1 is a view depicting an example of a configuration of an information processing system according to an embodiment of the present technology.

The information processing system of FIG. 1 includes a game machine 1 and a TV (television receiver) 2 connected to each other by a cable of a predetermined standard such as HDMI (registered trademark) (High-Definition Multimedia Interface) 2.0a or HDMI 2.1. The game machine 1 and the TV 2 may be connected to each other otherwise through a wireless interface.

The game machine 1 is an information processing apparatus that executes game software recorded on an optical disk 11 or game software provided from a predetermined server through the Internet 12. The game software executed by the game machine 1 is a program of a game that uses HDR video.

The game machine 1 outputs data of HDR video obtained by execution of game software to the TV 2 such that an image of the game is displayed on the TV 2. The data outputted from the game machine 1 includes not only data of HDR video but also audio data.

The TV 2 is an image processing apparatus that has, in addition to a function of receiving and displaying a broadcasting program transmitted as a broadcasting wave or by using a network as a transmission line, a function of displaying video inputted from the outside.

A display the TV 2 has is a display ready for displaying of HDR video whose luminance exceeds 100 nit. In the example of FIG. 1, the highest luminance of the display the TV 2 has is 500 nit. The TV 2 receives respective pictures of the HDR video transmitted from the game machine 1 and displays images of a game.

### <Luminance Adjustment>

Here, general luminance adjustment of HDR video is described.

As described hereinabove, also in the case where the same HDR video is inputted to a TV ready for displaying of HDR video, when the performance of the display of the TV differs, the appearance of an image differs.

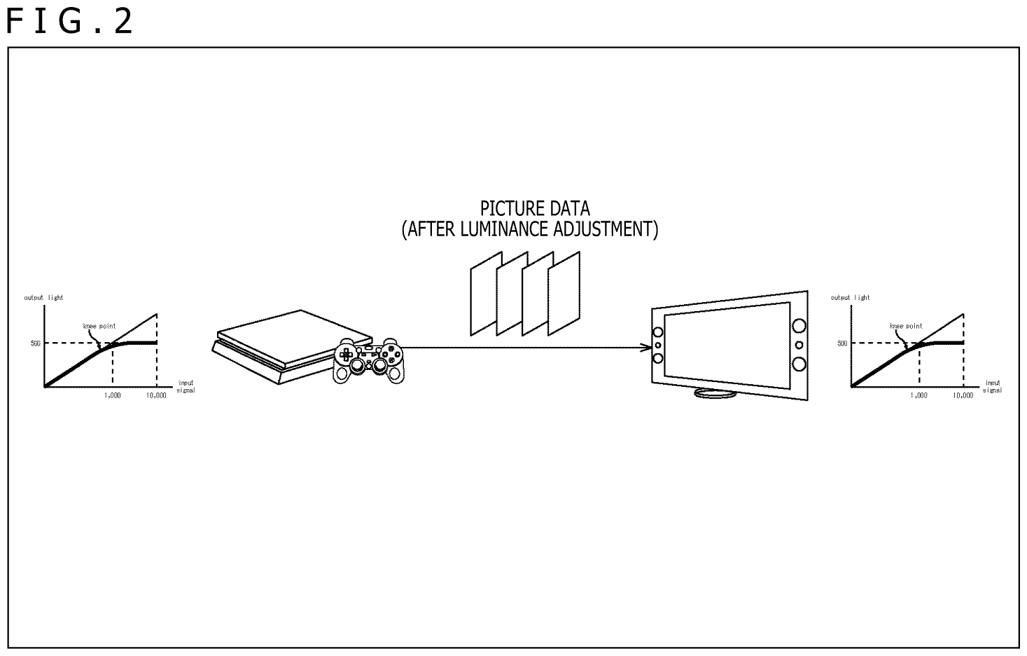

One of causes of this is that luminance adjustment is performed on both the game machine side and the TV side as depicted in FIG. 2. The luminance adjustment (tone map) includes compression and decompression of the luminance. For example, the game machine and the TV have information of a tone curve representative of an input/output characteristic of luminance. The luminance adjustment is performed using such a tone curve as just described.

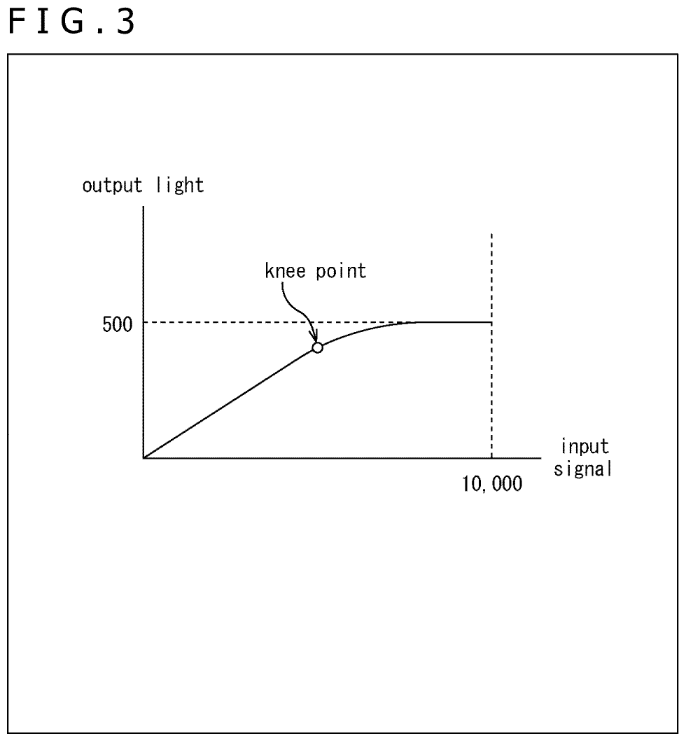

FIG. 3 is a view depicting an example of a tone curve used in luminance adjustment of HDR video.

The axis of abscissa of FIG. 3 represents the luminance of an input signal, and the axis of ordinate represents the luminance of an output (display). Luminance adjustment in which such a tone curve representative of an input/output characteristic of the luminance as just described is performed, and the luminance of HDR video is compressed so as to fit in a range of 500 nit that is the highest luminance of the display.

It is to be noted that a point that is indicated at an arrow tip in FIG. 3 and at which the expression of light and dark changes from a linear state (point at which the input luminance and the output luminance are no longer in the linear state) is called a knee point. An input signal of a luminance higher than the knee point is outputted with a luminance lower than the relevant luminance.

In the case where data of respective pictures subjected to luminance adjustment is outputted from the game machine to the TV as depicted in FIG. 2, since it is not known to the TV side that luminance adjustment has already been performed, luminance adjustment is performed again also on the TV side. In this case, the luminance adjustment intended by the game machine is overwritten by the luminance adjustment on the TV side.

In order to prevent such overwriting of luminance adjustment, a method by which luminance adjustment of HDR video is not performed by the game machine side but the game machine controls the luminance adjustment to be performed on the TV is conceivable.

Further, as means for allowing the game machine to control the luminance adjustment to be performed on the TV, means for adding and transmitting information representative of a feature of the luminance as metadata to and together with respective pictures is conceivable. For example, SMPTE2094-40 prescribes, as metadata of HDR video, Dynamic metadata including information representative of a feature of luminance of a picture (frame) unit.

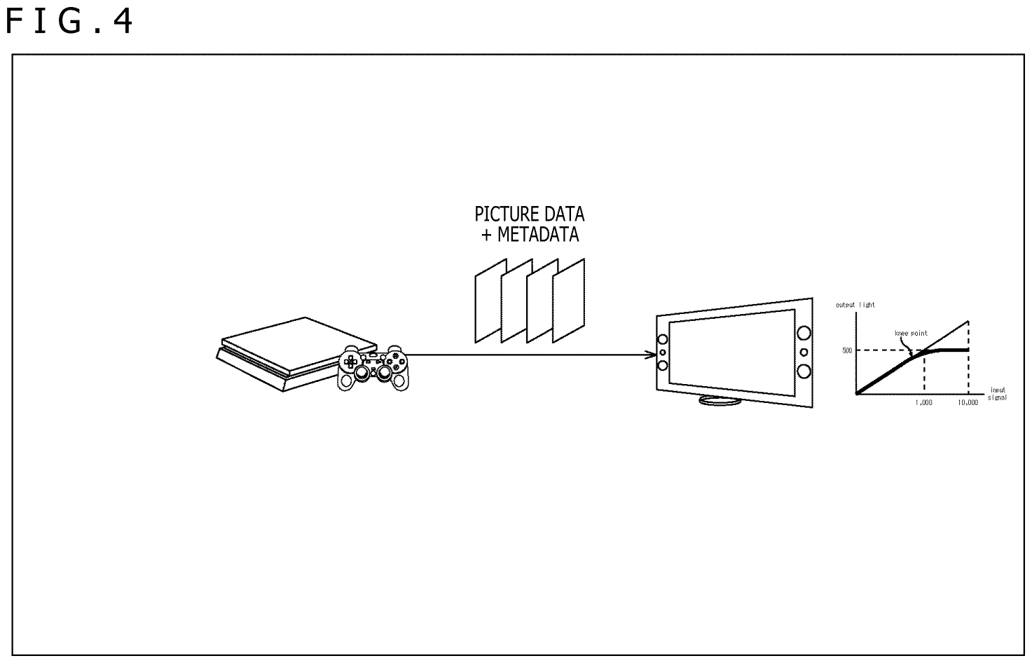

If the Dynamic metadata is adopted also for HDR video configuring an image of a game, then, at the time of outputting of HDR video, the Dynamic metadata is transmitted together with data of respective pictures from the game machine to the TV as depicted in FIG. 4. In the TV, luminance adjustment of the HDR video is performed on the basis of the Dynamic metadata transmitted thereto from the game machine.

<Dynamic metadata>

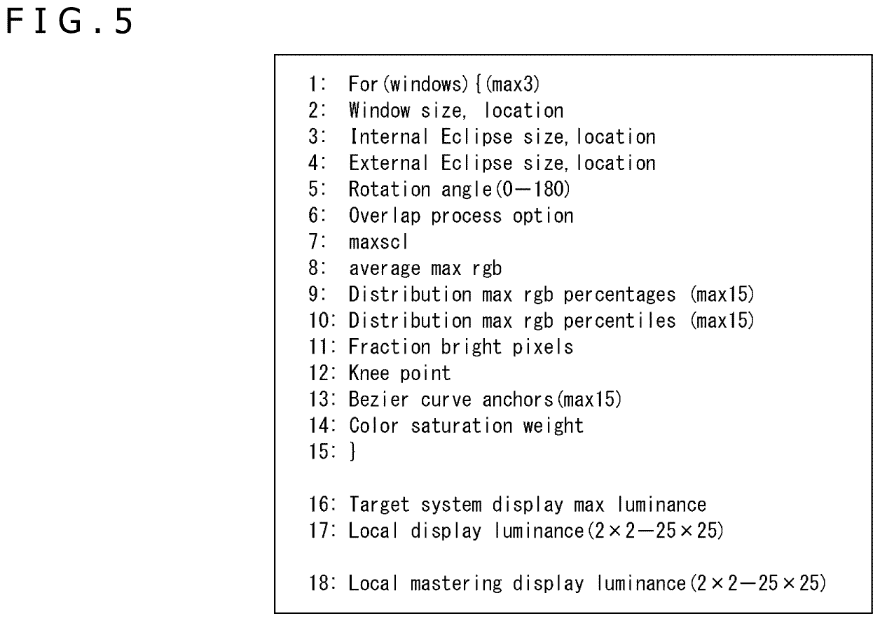

FIG. 5 is a view depicting syntax of the Dynamic metadata prescribed by SMPTE2094-40. It is to be noted that the meaning of the respective fields depicted in FIG. 5 is defined by CTA861-G.

As indicated in the first line of FIG. 5, in the Dynamic metadata, information of a Window set in a picture is described. The Window is a rectangular region set in a picture. It is possible to set a maximum of three Windows in one picture.

Parameters in the second to fourteenth lines are described for each of the Windows set in a picture.

Window size and Window location in the second line indicate a size and a position of the Window, respectively.

Internal Eclipse size and Internal Eclipse location in the third line indicate a size and a position of an ellipse on the inner side from between two ellipses set in the Window, respectively. It is made possible to set an ellipse in the Window and designate a luminance in the ellipse.

External Eclipse size and External Eclipse location in the fourth line indicate a size and a position of the outer side ellipse from between the two ellipses set in the Window, respectively.

Rotation angle in the fifth line indicates an inclination of the two ellipses set in the Window.

Overlap process option in the sixth line indicates a processing method for a pixel in the case where Windows overlap with each other.

maxscl in the seventh line indicates RGB values of a pixel that is brightest in the Window.

average max rgb in the eighth line indicates an average of the highest values among R, G, and B of the pixels in the Window.

Distribution max rgb percentages in the ninth line indicates a rank of a bright luminance in the Window in a ranking in percentage terms. It is possible to describe 15 values of Distribution max rgb percentages in the maximum.

Distribution max rgb percentiles in the tenth line indicates a rank of a bright luminance in the Window in ranking (percentile). It is possible to describe 15 values of Distribution max rgb percentiles in the maximum.

Fraction bright pixels in the eleventh line indicates a degree by which a maximum luminance value in a scene is drawn.

Knee point in the twelfth line indicates a luminance value of the knee point described hereinabove.

Bezier curve anchors in the thirteenth line indicates coordinates x and y of a sample (anchor point) on a tone curve of the brightness exceeding the knee point. It is possible to designate 15 anchor points in the maximum in Bezier curve anchors.

Color saturation weight in the fourteenth line indicates a value to be used for correction of RGB values that change when luminance compression is performed by a supposed display (Target display).

Target System display max luminance in the sixteenth line indicates a luminance of the supposed display. It is designated by Target System display max luminance that a piece of content is created assuming that it is displayed on a display of such a type as just described.

Local display luminance in the seventeenth line indicates a maximum luminance value of each area in the case where the display is divided into vertical and horizontal 2×2 to 25×25 areas.

Local mastering display luminance in the eighteenth line indicates a maximum luminance value in each area in the case where the mastering display is divided into vertical and horizontal 2×2 to 25×25 areas.

In the case where the number of Window is one, attributes of a picture are indicated by parameters in the first to fifteenth lines. Further, attributes of the supposed display are indicated by parameters in the sixteenth line and the seventeenth line, and an attribute of the display used for creation of an image of a game is indicated by a parameter in the eighteenth line.

In such a manner, according to the Dynamic metadata prescribed by SMPTE2094-40, information of only one knee point can be prescribed.

In particular, in the case where it is intended to control the luminance adjustment on the TV side by using such Dynamic metadata as described above, the game machine can designate a knee point, for example, only on the higher luminance side and cannot designate a luminance on the lower luminance side. In the case where it is intended to display a knee point on the higher luminance side, while it is desired to represent a luminance of an input signal as it is as a luminance, although the game machine can designate, a luminance on the higher luminance side, it cannot designate a luminance on the lower luminance side.

Depending upon a tone curve the TV has, the luminance is excessively compressed on the lower luminance side, and an image especially of a dark scene cannot be represented sufficiently.

### <Game Metadata>

In the information processing system of FIG. 1, the game machine 1 side does not perform luminance adjustment of HDR video, and luminance adjustment to be performed on the TV 2 can be controlled by the game machine 1.

The control of luminance adjustment performed on the TV 2 is performed using game metadata that is metadata including descriptions similar to those of the Dynamic metadata. The game metadata is added to each picture of HDR video, which configures an image of a game, by the game machine 1 and is transmitted to the TV 2.

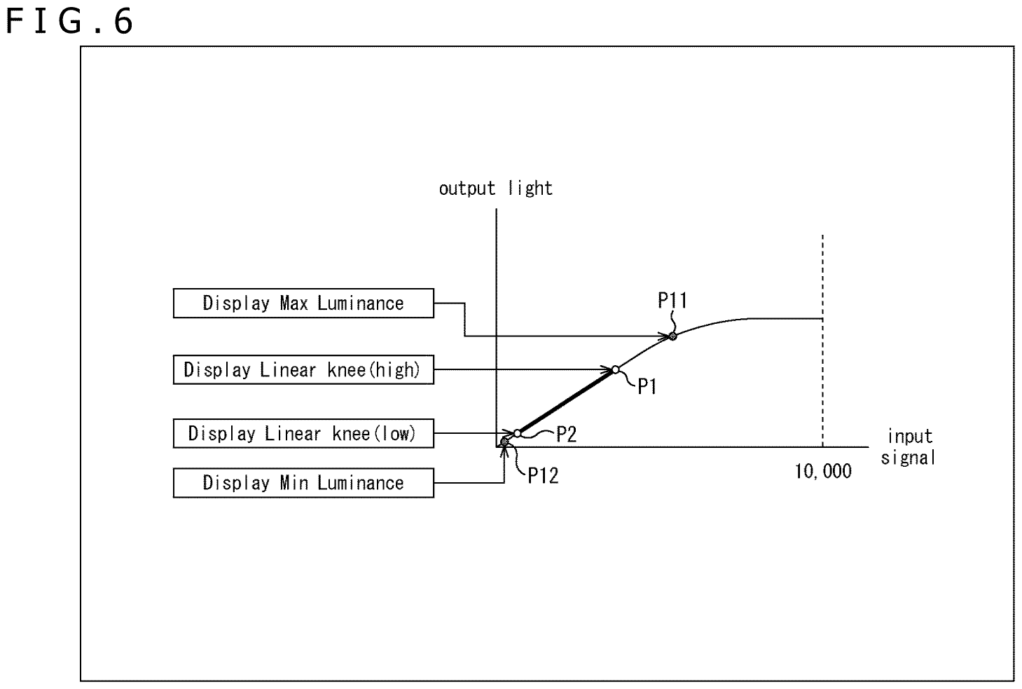

FIG. 6 is a view depicting a knee point represented by the game metadata.

The game metadata outputted from the game machine 1 includes information representative of a knee point on the higher luminance side indicated as a point P1 and information representative of a knee point on the lower luminance side indicated as a point P2. A section between the points P2 and P1 indicated by a thick line is a section in which the luminance of the input signal is indicated keeping its luminance (linear section).

The input signal of a higher luminance than that at the point P1 is indicated such that the luminance is compressed in a range up to a maximum luminance indicated by a point P11 according to the tone curve on the right side with respect to the point P1. On the other hand, the input signal of a lower luminance than that at the point P2 is indicated such that the luminance is expanded within a range down to the lowest luminance indicated at a point P12 according to the tone curve on the left side with respect to the point P2.

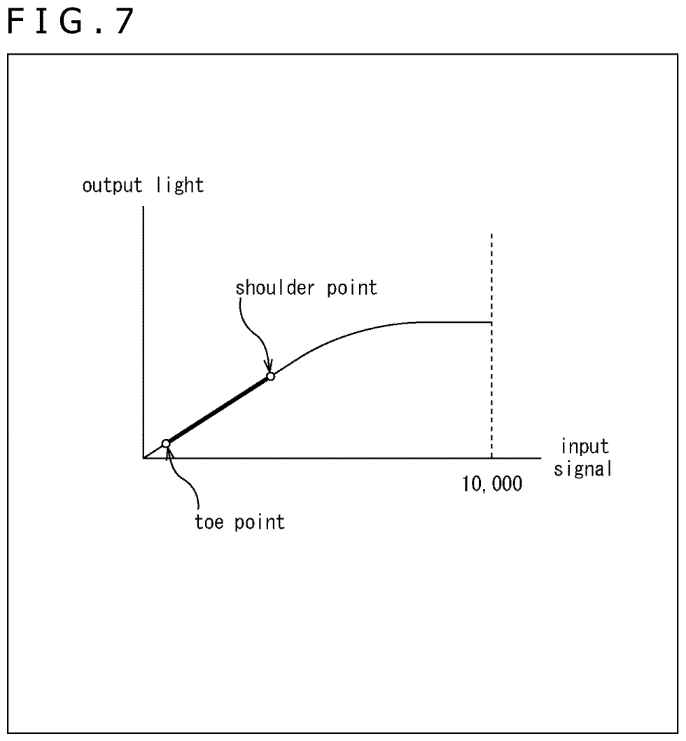

In the following, the knee point on the higher luminance side corresponding to the point P1 is suitably referred to as a shoulder point and the knee point on the lower luminance side corresponding to the point P2 is suitably referred to as a toe point as depicted in FIG. 7.

Further, in regard to descriptions in the game metadata, they are represented in a form including a capital letter alphabet like Knee point, and in regard to a point on the tone curve, it is represented in a form including small letter alphabets like knee point. For example, Shoulder point represents a description in game metadata, and shoulder point represents a point on a tone curve.

By designating a shoulder point and a toe point, the game machine 1 can cause the TV 2 to appropriately perform luminance adjustment of HDR video configuring an image of a game.

### Example 1 of Descriptions of Game Metadata

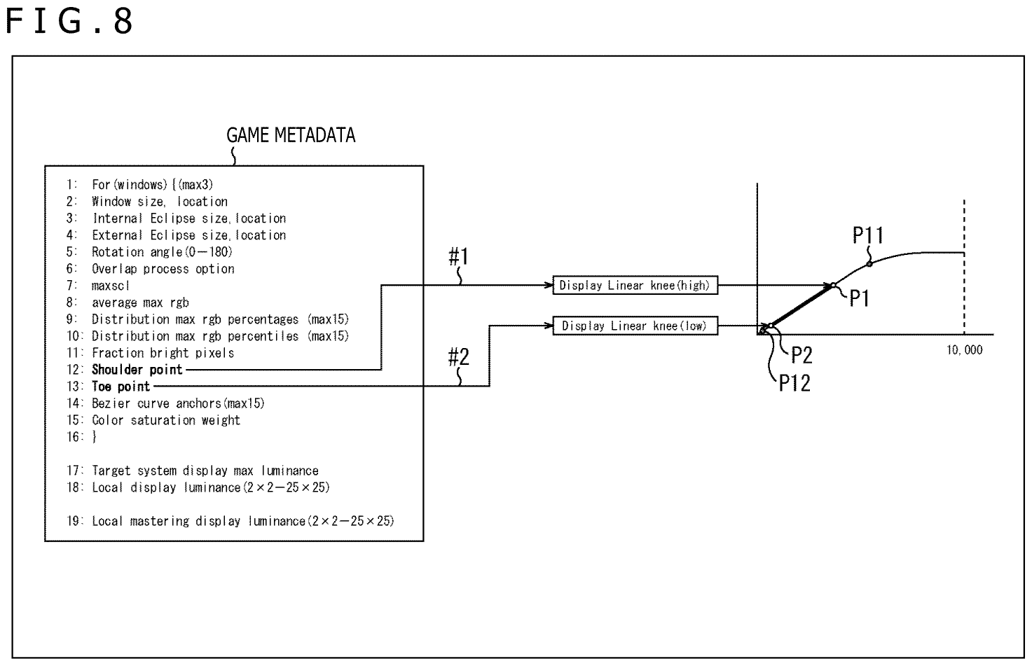

FIG. 8 is a view depicting a first example of the syntax of game metadata.

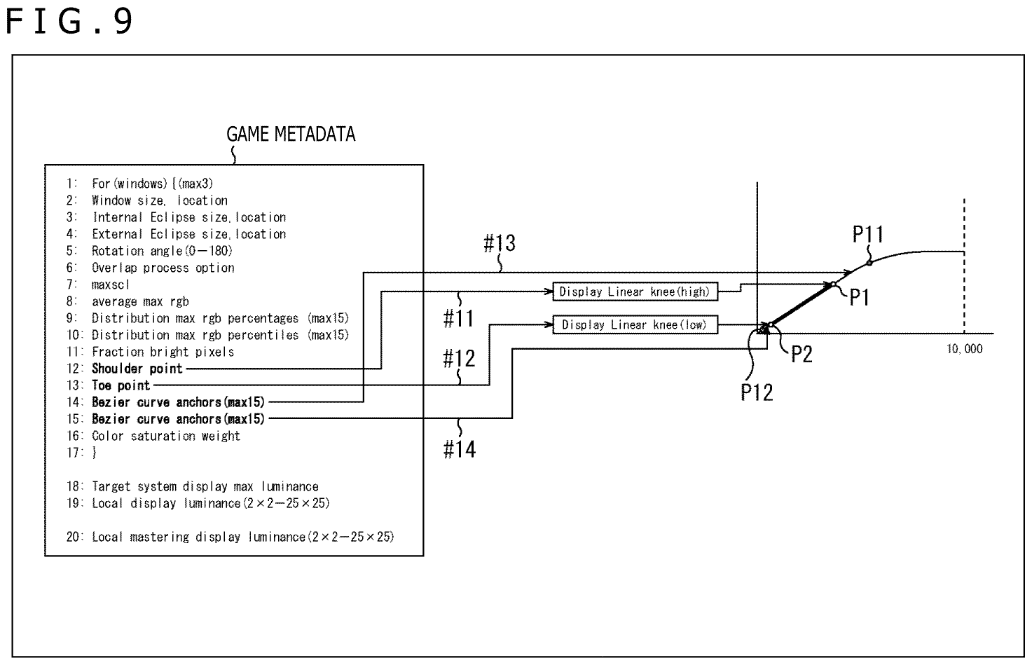

Of the descriptions of the game metadata depicted in FIG. 8, in regard to a description that overlaps with a description described hereinabove with reference to FIG. 5, description is omitted suitably. This similarly applies to FIG. 9 and so forth.

In the example of FIG. 8, the descriptions are different from those in FIG. 5 in that Shoulder point and Toe point are described in place of Knee point.

Shoulder point in the twelfth line represents a shoulder point that is a knee point on the higher luminance side as indicated by an arrow mark #1.

Toe point in the thirteenth line represents a toe point that is a knee point on the lower luminance side as indicated by an arrow mark #2.

In particular, the descriptions of FIG. 8 are descriptions in the case where the Dynamic metadata that newly defines a new field is used as game metadata.

The game machine 1 generates game metadata including the descriptions of FIG. 8 by executing game software and adds and transmits the generated game metadata to and together with individual pictures.

This makes it possible for the game machine 1 to designate each of a shoulder point and a toe point. In the TV 2, luminance adjustment is performed on the basis of the game metadata, and an input signal of a luminance between the shoulder point and the toe point is outputted keeping the luminance as it is.

It is to be noted that Bezier curve anchors in the fourteenth line indicates, for example, an anchor point on the higher luminance side than the shoulder point. An anchor point on the lower luminance side than the toe point may otherwise be indicated by Bezier curve anchors.

### Example 2 of Descriptions of Game Metadata

FIG. 9 is a view depicting a second example of the syntax of game metadata.

In the example of FIG. 9, the descriptions are different from those of FIG. 5 in that Shoulder point and Toe point are described in place of Knee point. Further, the descriptions of FIG. 9 are different from those of FIG. 5 in that they include two descriptions of Bezier curve anchors.

Shoulder point in the twelfth line represents a shoulder point that is a knee point on the higher luminance side as indicated by an arrow mark #11.

Toe point in the thirteenth line represents a toe point that is a knee point on the lower luminance side as indicated by an arrow mark #12.

Bezier curve anchors in the fourteenth line indicates coordinates x and y of an anchor point on the higher luminance side than the shoulder point as indicated by an arrow mark #13. By Bezier curve anchors in the fourteenth line, fifteen anchor points on the higher luminance side than the shoulder point are designated in the maximum.

Bezier curve anchors in the fifteenth line indicates coordinates x and y of an anchor point on the lower luminance side than the toe point as indicated by an arrow mark #14. By Bezier curve anchors in the fifteenth line, fifteen anchor points on the lower luminance side than the toe point are designated in the maximum.

The descriptions of FIG. 9 are also descriptions in the case where Dynamic metadata that newly defines the new fields is used as game metadata.

The game machine 1 generates game metadata including the descriptions of FIG. 9 by executing game software and adds and transmits the generated game metadata to and together with individual pictures.

This makes it possible for the game machine 1 to designate each of a shoulder point and a toe point. Further, it becomes possible for the game machine 1 to designate an input/output characteristic on the higher luminance side than the shoulder point and an input/output characteristic on the lower luminance side than the toe point.

### Example 3 of Descriptions of Game Metadata

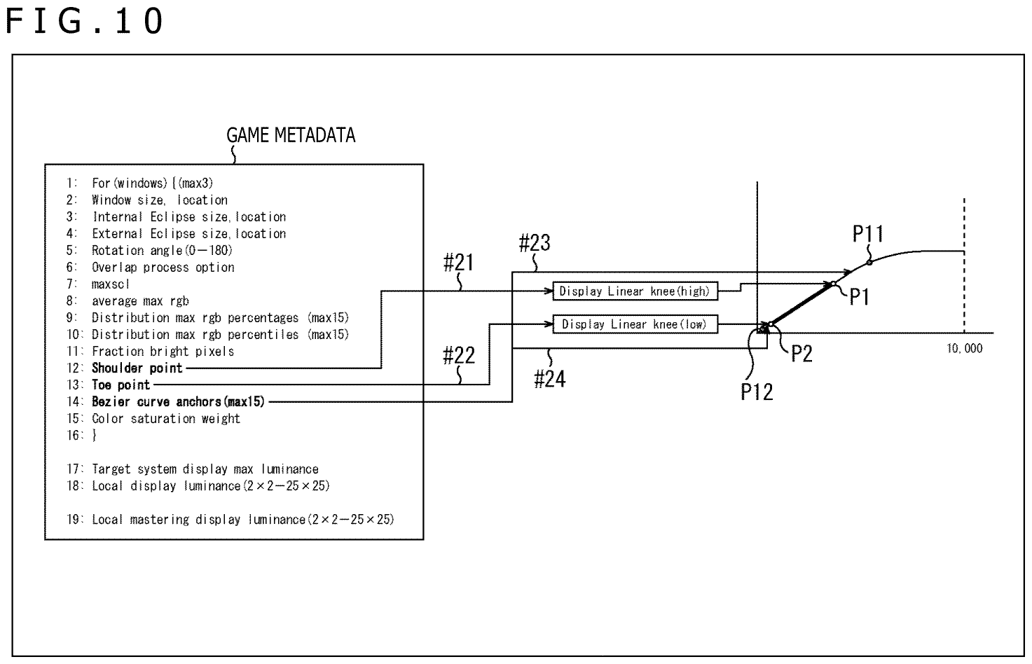

FIG. 10 is a view depicting a third example of the syntax of game metadata.

In the example of FIG. 10, the descriptions are different from those of FIG. 5 in that Shoulder point and Toe point are described in place of Knee point. Further, meaning of Bezier curve anchors is different the meaning of Bezier curve anchors of FIG. 5.

Shoulder point in the twelfth line represents a shoulder point that is a knee point on the higher luminance side as indicated by an arrow mark #21.

Toe point in the thirteenth line represents a toe point that is a knee point on the lower luminance side as indicated by an arrow mark #22.

Bezier curve anchors in the fourteenth line designates, for example, 15 anchor points.

For example, eight anchor points in the former half among the 15 anchor points indicated by Bezier curve anchors indicate coordinates x and y of anchor points on the higher luminance side than the shoulder point as indicated by an arrow mark #23. Further, the seven anchor points on the latter half from among the 15 anchor points indicate coordinates x and y of anchor points on the lower luminance side than the toe point as indicated by an arrow mark #24.

In such a manner, for example, a greater amount of information of Bezier curve anchors is allocated to the anchor points on the higher luminance side than that to the anchor points on the lower luminance side.

The ratio of the amount of information of Bezier curve anchors to be allocated to the anchor points on the higher luminance side and the anchor points on the lower luminance side can be changed optionally. For example, a greater amount of information of Bezier curve anchors may otherwise be allocated to the anchor points on the lower luminance side than to the anchor points on the higher luminance side.

Further, a predetermined number of anchor points smaller than 15 may be designated by Bezier curve anchors.

The descriptions of FIG. 10 are also descriptions in the case where Dynamic metadata that newly defines the new fields is used as game metadata.

The game machine 1 generates game metadata including the descriptions of FIG. 10 by executing game software and adds and transmits the generated game metadata to and together with individual pictures.

This makes it possible for the game machine 1 to designate a shoulder point and a toe point individually. Further, it becomes possible for the game machine 1 to designate an input/output characteristic on the higher luminance side than the shoulder point and an input/output characteristic on the lower luminance side than the toe point.

### Example 4 of Descriptions of Game Metadata

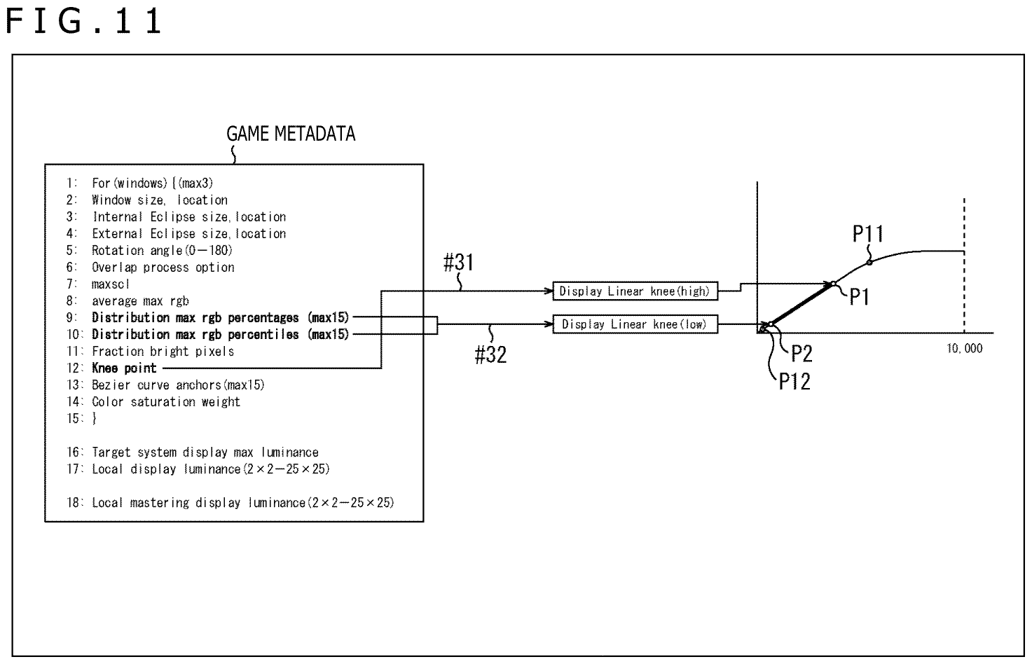

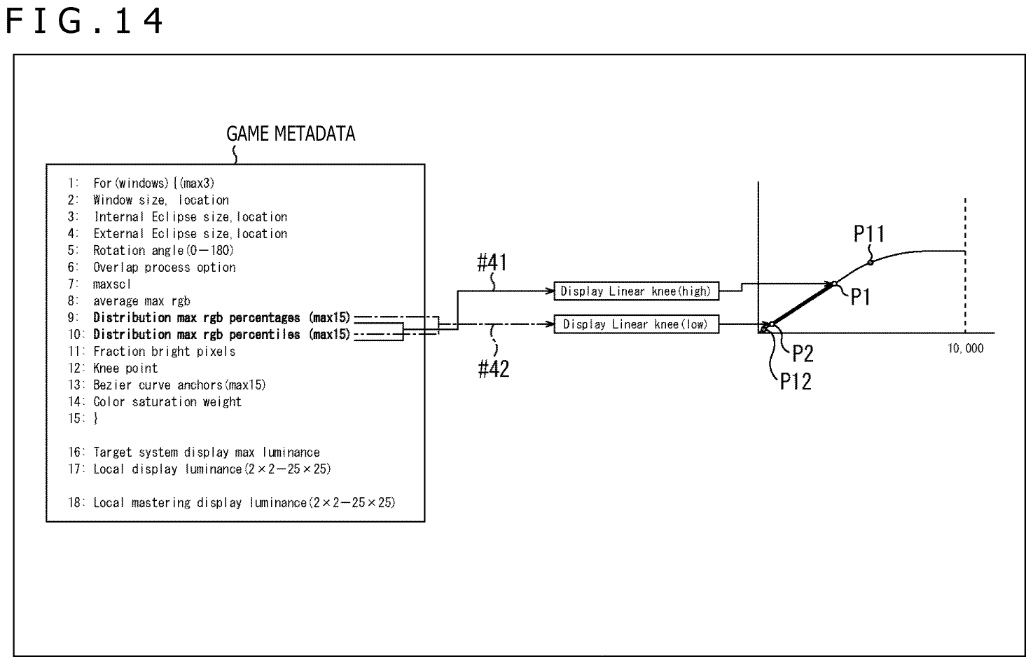

The syntax indicated in FIG. 11 and the syntax depicted in FIG. 14 hereinafter described are syntaxes that use existing descriptions to represent a shoulder point, a toe point and so forth without including a new field. The descriptions in FIGS. 11 and 14 are descriptions in the case where existing descriptions of the Dynamic metadata are used as they are, as game metadata.

### Example 4-1 of Descriptions

FIG. 11 is a view depicting a first one of a fourth example of the syntax of metadata.

Knee point in the twelfth line represents a shoulder point that is a knee point on the higher luminance side as indicated by an arrow mark #31.

A toe point that is a knee point on the lower luminance side is represented using Distribution max rgb percentages in the ninth line and Distribution max rgb percentiles in the tenth line as indicated by an arrow mark #32.

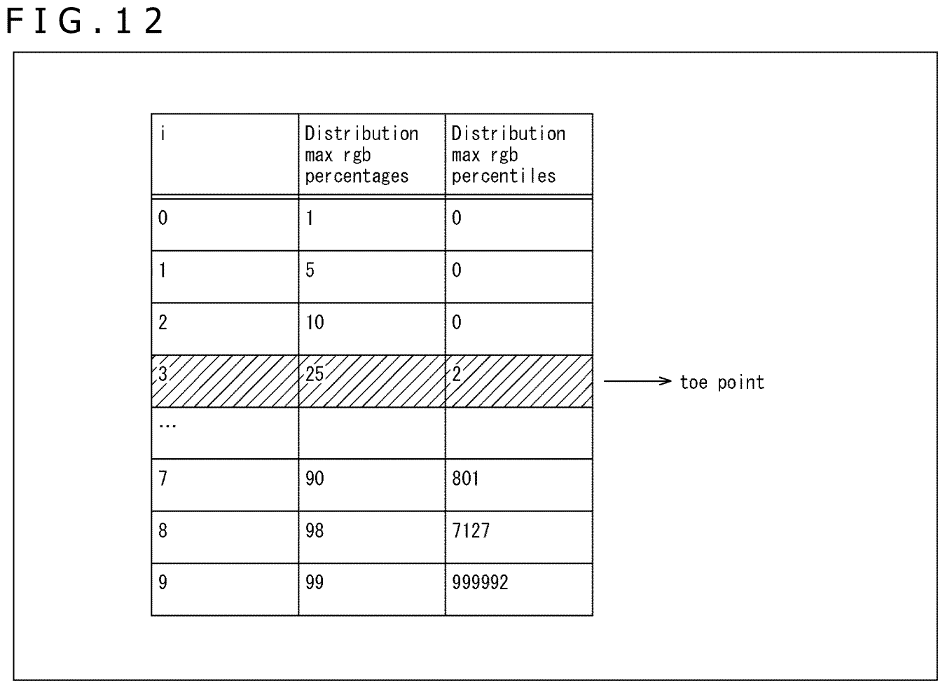

FIG. 12 is a view depicting a particular example of Distribution max rgb percentages and Distribution max rgb percentiles.

In a table depicted in FIG. 12, a left end column represents a variable i. The variable i assumes integers from 0 to 14. The number of values of Distribution max rgb percentages and Distribution max rgb percentiles equal to the number of variables i are set. A middle column represents Distribution max rgb percentages, and a left end column represents Distribution max rgb percentiles.

In the example of FIG. 12, Distribution max rgb percentages and Distribution max rgb percentiles corresponding to the variables i=0 to 9 are indicated.

The value x[i] of Distribution max rgb percentages represents, if the number of Windows is one, the ratio of pixels when all pixels configuring a picture are arranged in the ascending order of the luminance and are counted in the ascending order of the luminance. For example, the value of Distribution max rgb percentages being 90 in the case of variable i=7 represents pixels included in the range of 90% from the lowest luminance.

Meanwhile, the value y[i] of Distribution max rgb percentiles represents, if the number of Windows is one, the luminance of a pixel, whose luminance is highest within the range represented by Distribution max rgb percentages, in a normalized form. For example, the value of Distribution max rgb percentiles being 801 in the case of the variable i=7 represents that the luminance of a picture that has a maximum luminance from among pixels included in the range of 90% from the lowest luminance is 80.1 nit.

As indicated by slanting lines added in FIG. 12, for example, a toe point is represented using Distribution max rgb percentages and Distribution max rgb percentiles corresponding to the variable i=3. In the example of FIG. 12, the value of Distribution max rgb percentages corresponding to the variable i=3 is 25 (25%). Meanwhile, the value of Distribution max rgb percentiles corresponding to the variable i=3 is 2 (0.2 nit).

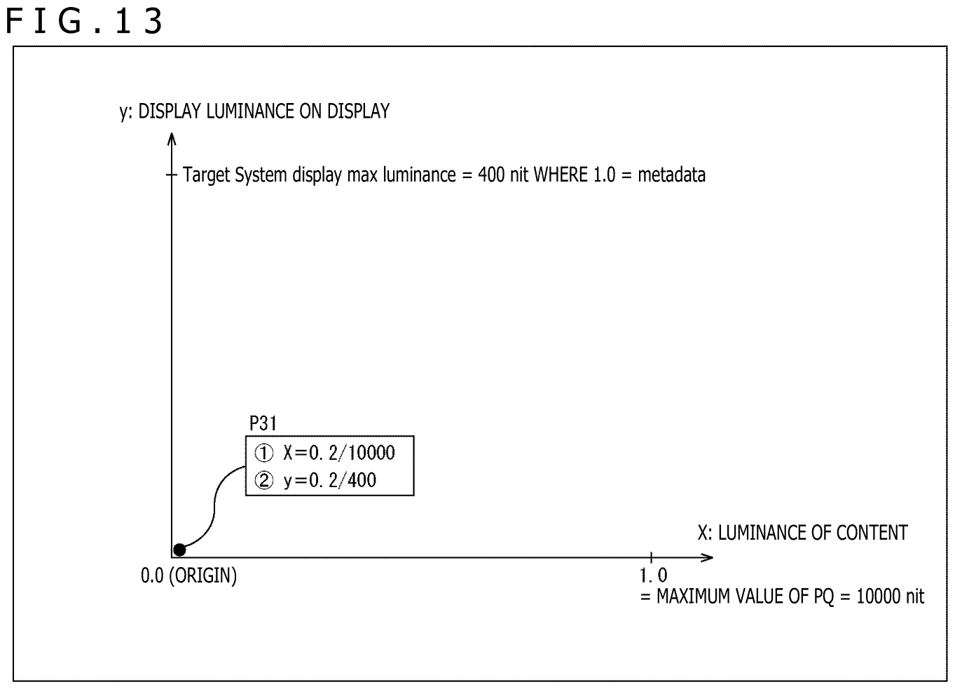

FIG. 13 is a view depicting an example of a determination method of a toe point.

The axis of abscissa of FIG. 13 represents the luminance of an input signal. The value of x being 1.0 represents 10000 nit that is a maximum luminance value of PQ (Perceptual Quantization).

Meanwhile, the axis of ordinate of FIG. 13 represents the display luminance on the display. The value of y being 1.0 represents, for example, 400 nit that is a maximum luminance of the display. The maximum luminance of the display is represented by Target System display max luminance of game metadata.

As described hereinabove, a toe point is a boundary point of a linear range in which an input signal of a certain luminance is represented by the luminance. Since the value of Distribution max rgb percentiles corresponding to the variable i=3 is 0.2, the x coordinate and the y coordinate of a point P31 indicating that both the luminance of the input signal and the display luminance are 0.2 are represented by the following expression (1).

[Math. 1]

X=0.1/10000

y=0.2/400 (1)

According to CTA861-G, the Knee point is information of 12 bits. The values of the x coordinate and the y coordinate of the point P31 are converted into values nearest to multiples of 1/4095 as represented by the following expressions (2) and (3).

[Math. 2]

X=(0.2*4095/10000)/4095

y=(0.2*4095/400)/4095 (2)

[Math. 3]

Toe_point_x=0.2*4095/10000=0.0819

Toe_point_y=0.2*4095/400=2.0475 (3)

Representing the value of the x coordinate of the toe point calculated according to the expression (3), 0.0819 is rounded to 0, and representing the value of the y coordinate, 2.0475 is rounded to 2. Consequently, the x coordinate and the y coordinate of the toe point are represented by the following expression (4).

[Math. 4]

Toe_point_x=0

Toe_point_y=2 (4)

In such a manner, in the example of FIG. 11, Distribution max rgb percentages and Distribution max rgb percentiles corresponding to the predetermined variable i set in advance are used as information that designates a toe point.

The value of the variable i of Distribution max rgb percentages and Distribution max rgb percentiles that are used to designate a toe point is freely selected. It is possible to use Distribution max rgb percentages and Distribution max rgb percentiles corresponding, for example, to the variable i=4 other than the variable i=3 to designate a toe point.

The toe point may otherwise be designated by Knee point, and the shoulder point may be designated using Distribution max rgb percentages and Distribution max rgb percentiles.

The game machine 1 generates game metadata including the descriptions of FIG. 11 by executing game software and adds and transmits the generated game metadata to and together with individual pictures.

In the TV 2, analysis of the game metadata is performed, and a shoulder point is specified on the basis of the description of Knee point and a toe point is specified on the basis of the descriptions of Distribution max rgb percentages and Distribution max rgb percentiles.

Further, in the TV 2, luminance adjustment is performed using the specified shoulder point and toe point. In the case of the example described above, the luminance adjustment is performed such that, for pixels within the range of the luminance equal to higher than 25% when counted from the lowest luminance (pixels having luminances equal to or lower than that represented by the shoulder point), the luminance of the input signal is outputted as it is, as a luminance.

In such a manner, it is possible for the game machine 1 to designate a shoulder point and a toe point individually by using existing descriptions.

### Description Example 4-2

FIG. 14 is a view depicting a second one of the fourth example of the syntax of game metadata.

In the example of FIG. 14, both a shoulder point and a toe point are represented using Distribution max rgb percentages and Distribution max rgb percentiles as indicated by arrow marks #41 and #42.

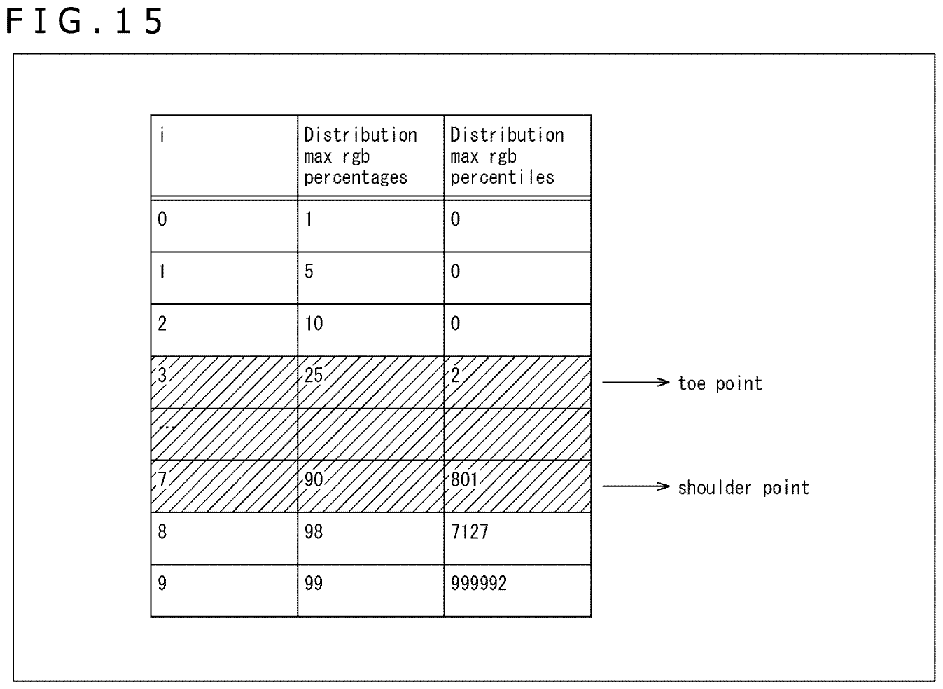

FIG. 15 is a view depicting a particular example of Distribution max rgb percentages and Distribution max rgb percentiles.

As depicted in FIG. 15, a toe point is represented using Distribution max rgb percentages and Distribution max rgb percentiles, for example, corresponding to the variable i=3. In the example of FIG. 15, the value of Distribution max rgb percentages corresponding to the variable i=3 is 25 (25%). Meanwhile, the value of Distribution max rgb percentiles corresponding to the variable i=3 is 2 (0.2 nit).

Further, a shoulder point is represented using Distribution max rgb percentages and Distribution max rgb percentiles, for example, corresponding to the variable i=7. In the example of FIG. 15, the value of Distribution max rgb percentages corresponding to the variable i=7 is 90 (90%). Meanwhile, the value of Distribution max rgb percentiles corresponding to the variable i=7 is 801 (80.1 nit).

A range indicated by slanting lines added in FIG. 15 is a range for which luminance adjustment is performed such that the luminance of an input signal is outputted as it is as a luminance.

In such a manner, in the example of FIG. 15, Distribution max rgb percentages and Distribution max rgb percentiles corresponding to a predetermined variable i set in advance are used as information for designating a toe point. Further, Distribution max rgb percentages and Distribution max rgb percentiles corresponding to another variable i set in advance are used as information for designating a shoulder point.

The values of the variable i corresponding to Distribution max rgb percentages and Distribution max rgb percentiles used to represent a shoulder point and a toe point is freely selected.

The game machine 1 generates game metadata including the descriptions of FIG. 14 by executing game software and adds and transmits the generated game metadata to and together with individual pictures.

In the TV 2, analysis of the game metadata is performed, and a shoulder point and a toe point are specified on the basis of the descriptions of Distribution max rgb percentages and Distribution max rgb percentiles.

Further, in the TV 2, luminance adjustment is performed using the specified shoulder point and toe point. In the case of the example described above, the luminance adjustment is performed such that, for pixels within the range of the luminance of 25% to 90% when counted from the lowest luminance, the luminance of an input signal is outputted as it is as a luminance.

In such a manner, it is possible for the game machine 1 to designate a shoulder point and a toe point using the existing descriptions.

### Description Example 4-3

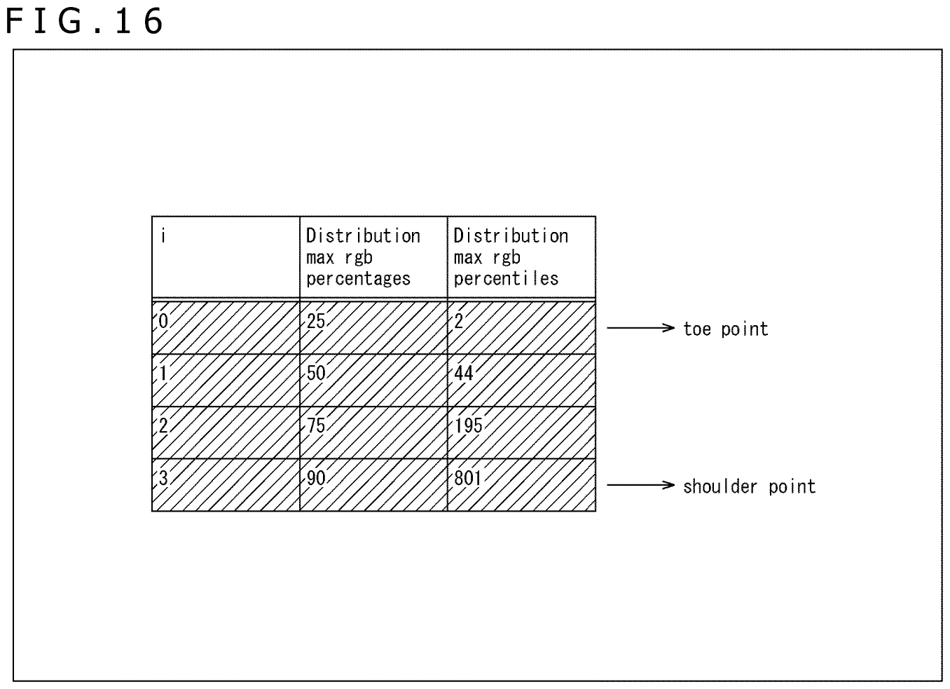

FIG. 16 is a view depicting a particular example of Distribution max rgb percentages and Distribution max rgb percentiles.

In the example of FIG. 16, only Distribution max rgb percentages and Distribution max rgb percentiles indicative of a range of the luminance in which the luminance of an input signal is outputted as it is as a luminance are described in the game metadata.

In the example of FIG. 16, values of Distribution max rgb percentages and Distribution max rgb percentiles corresponding to the variable i=0 to 3 are indicated.

As depicted in FIG. 16, a toe point is designated using Distribution max rgb percentages and Distribution max rgb percentiles corresponding to the variable i=0. In the example of FIG. 16, the value of Distribution max rgb percentages corresponding to the variable i=0 is 25. Further, the value of Distribution max rgb percentiles corresponding to the variable i=0 is 2.

Meanwhile, a shoulder point is represented using Distribution max rgb percentages and Distribution max rgb percentiles corresponding to the variable i=3. In the example of FIG. 16, the value of Distribution max rgb percentages corresponding to the variable i=3 is 90. Further, the value of Distribution max rgb percentiles corresponding to the variable i=3 is 801.

In such a manner, in the example of FIG. 16, Distribution max rgb percentages and Distribution max rgb percentiles corresponding to the smallest variable i are used as information for designating a toe point. Meanwhile, Distribution max rgb percentages and Distribution max rgb percentiles corresponding to the greatest variable i are used as information for designating a shoulder point.

### Example 5 of Descriptions of Game Metadata

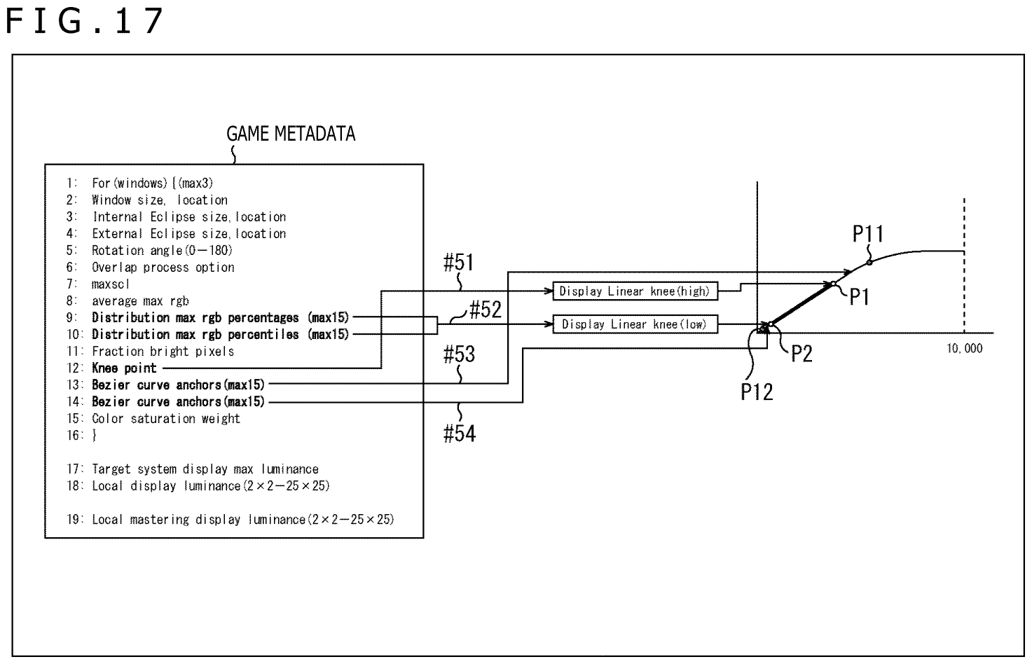

FIG. 17 is a view depicting a fifth example of the syntax of game metadata.

In the example of FIG. 17, the descriptions are different from those of FIG. 5 in that they include two descriptions of Bezier curve anchors.

Knee point in the twelfth line represents a shoulder point that is a knee point on the higher luminance side as indicated by an arrow mark #51.

A toe point that is a knee point on the lower luminance side is represented using Distribution max rgb percentages in the ninth line and Distribution max rgb percentiles in the tenth line as indicated by an arrow mark #52. The way of representing a toe point using Distribution max rgb percentages and Distribution max rgb percentiles is similar to those described hereinabove with reference to FIGS. 12, 15, and 16.

Bezier curve anchors in the thirteenth line indicates coordinates x and y of an anchor point on the higher luminance side than a shoulder point as indicated by an arrow mark #53.

Bezier curve anchors in the fourteenth line indicates coordinates x and y of an anchor point on the lower luminance side than a toe point as indicated by an arrow mark #54.

In particular, the descriptions of FIG. 17 are descriptions in the case where a shoulder point and a toe point are represented using the existing descriptions and the Dynamic metadata to which Bezier curve anchors is added is used as game metadata.

Also in the example of FIG. 17, a toe point may be represented by Knee point and a shoulder point may be represented using Distribution max rgb percentages and Distribution max rgb percentiles.

### Example 6 of Descriptions of Game Metadata

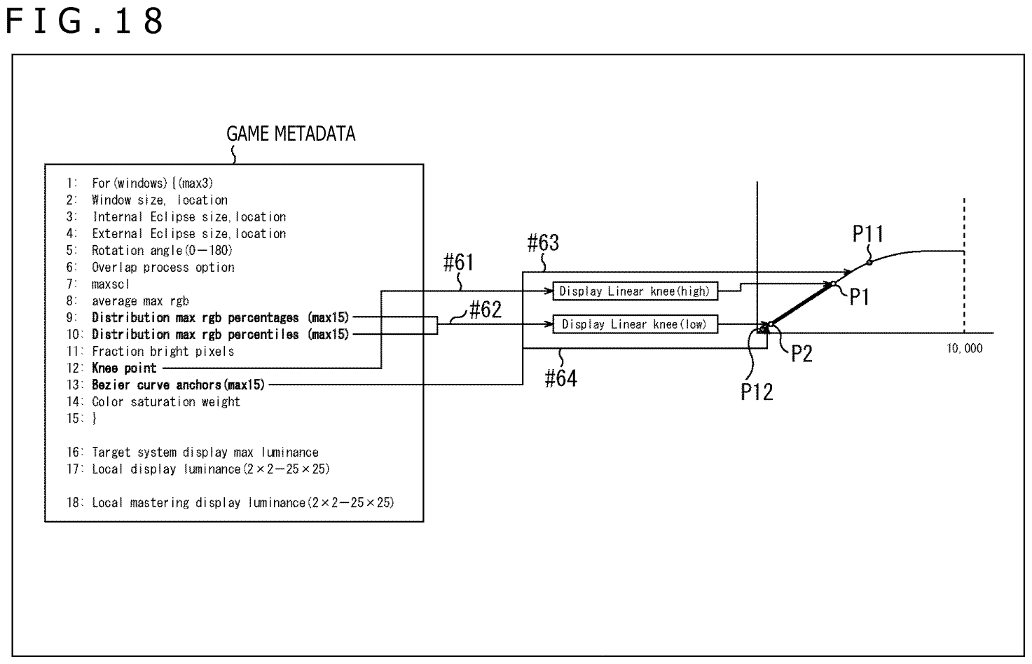

FIG. 18 is a view depicting a sixth example of the syntax of game metadata.

The descriptions of FIG. 18 are same as the descriptions of FIG. 5 except that the meaning of Bezier curve anchors is different. Bezier curve anchors depicted in FIG. 18 indicates an anchor point on the higher luminance side than a shoulder point and indicates an anchor point on the lower luminance side than a toe point as described hereinabove with reference to FIG. 10.

Knee point in the twelfth line represents a shoulder point that is a knee point on the higher luminance side as indicated by an arrow mark #61.

A toe point that is a knee point on the lower luminance side is represented using Distribution max rgb percentages in the ninth line and Distribution max rgb percentiles in the tenth line as indicated by an arrow mark #62.

For example, eight anchor points in the former half among 15 anchor points indicated by Bezier curve anchors in the thirteenth line indicate coordinates x and y of anchor points on the higher luminance side than the shoulder point as indicated by an arrow mark #63. Further, the seven anchor points on the latter half from among the 15 anchor points indicate coordinates x and y of the anchor points on the lower luminance side than the toe point as indicated by an arrow mark #64.

In such a manner, the examples of descriptions described above can be combined suitably.

By using game metadata including such various descriptions as described above, the game machine 1 can designate a shoulder point and a toe point individually.

The TV 2 can perform luminance adjustment of a picture of HDR video in an appropriate form in accordance with a method designated by the game machine 1, that is, in accordance with a method designated by a creator of game software.

### <<Configuration and Operation of Individual Apparatus>>

### <Configuration of Game Machine>

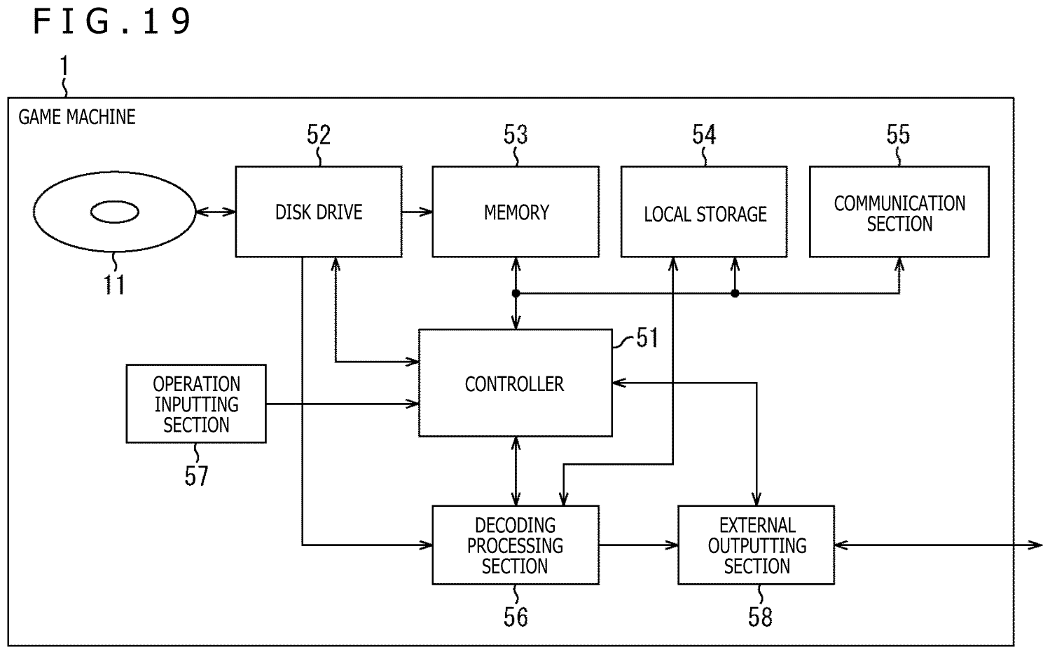

FIG. 19 is a block diagram depicting an example of a configuration of the game machine 1.

The game machine 1 includes a controller 51, a disk drive 52, a memory 53, a local storage 54, a communication section 55, a decoding processing section 56, an operation inputting section 57, and an external outputting section 58.

The controller 51 includes a CPU (Central Processing Unit), a ROM (Read Only Memory), a RAM (Random Access Memory) and so forth. The controller 51 executes a predetermined program to control operation of the entire game machine 1.

The disk drive 52 reads out data recorded on an optical disk 11 and outputs the data to the controller 51, the memory 53, or the decoding processing section 56. For example, the disk drive 52 outputs game software read out from the optical disk 11 to the controller 51 and outputs an AV stream to the decoding processing section 56.

The memory 53 stores data necessary for the controller 51 to execute various processes such as a program to be executed by the controller 51.

The local storage 54 includes a recording medium such as an HDD (Hard Disk Driver) or an SSD (Solid State Drive). Into the local storage 54, game software downloaded from a server and so forth are stored.

The communication section 55 is an interface such as a wireless LAN and a wired LAN. For example, the communication section 55 performs communication with a server through a network such as the Internet and supplies data downloaded from the server to the local storage 54.

The decoding processing section 56 decodes a video stream multiplexed in an AV stream supplied from the disk drive 52 and outputs data of video obtained by the decoding to the external outputting section 58. HDR video configuring an image of a game may be generated by decoding a video stream. Further, the decoding processing section 56 decodes an audio stream multiplexed in the AV stream and outputs audio data obtained by the decoding to the external outputting section 58.

The operation inputting section 57 includes a reception section that receives a signal transmitted by wireless communication from a remote controller. The operation inputting section 57 detects an operation of a user and supplies a signal representative of contents of the detected operation to the controller 51.

The external outputting section 58 is an interface for an external output such as an HDMI. The external outputting section 58 performs communication with the TV 2 through an HDMI cable and outputs data of HDR video supplied from the controller 51 or data of HDR video supplied from the decoding processing section 56 to the TV 2.

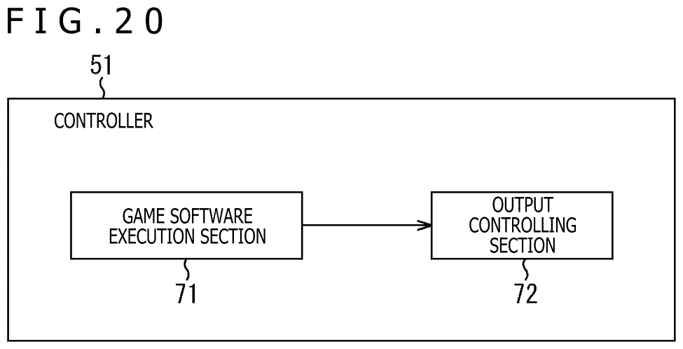

FIG. 20 is a block diagram depicting an example of a functional configuration of the controller 51.

In the controller 51, a game software execution section 71 and an output controlling section 72 are implemented. At least part of functioning sections depicted in FIG. 20 is implemented by a predetermined program executed by the CPU of the controller 51.

The game software execution section 71 executes game software read out from the optical disk 11 and game software recorded in the local storage 54.

The game software execution section 71 executes the game software to generate respective pictures of HDR video configuring images of a game and game metadata. The game software execution section 71 outputs the generated respective pictures of the HDR video and the game metadata to the output controlling section 72.

The output controlling section 72 controls the external outputting section 58 to control outputting of the HDR video generated by the game software execution section 71. For example, the output controlling section 72 adds the game metadata to the respective pictures of the HDR video configuring images of the game and controls the external outputting section 58 to output the respective pictures to which the game metadata is added.

### <Configuration of TV>

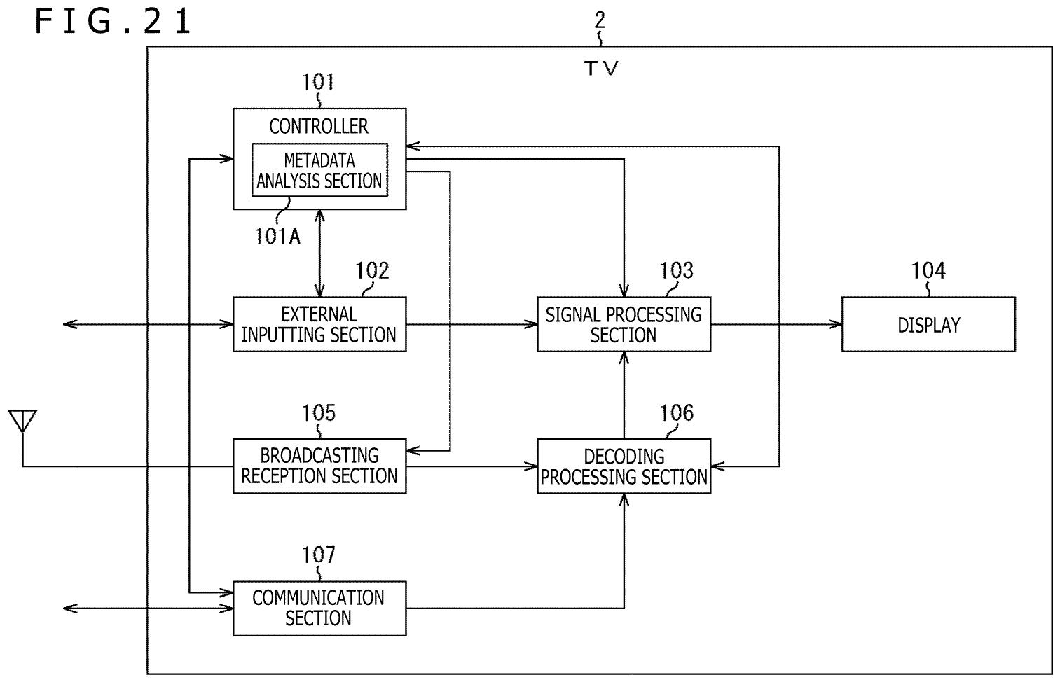

FIG. 21 is a block diagram depicting an example of a configuration of the TV 2.

The TV 2 includes a controller 101, an external inputting section 102, a signal processing section 103, a display 104, a broadcasting reception section 105, a decoding processing section 106, and a communication section 107.

The controller 101 includes a CPU, a ROM, a RAM and so forth. The controller 101 executes a predetermined program to control operation of the entire TV 2.

In the controller 101, a metadata analysis section 101A is implemented by execution of the predetermined program.

The metadata analysis section 101A analyzes the metadata transmitted thereto from the game machine 1 to specify a shoulder point and a toe point. Further, the metadata analysis section 101A analyzes the game metadata to also perform specification of an anchor point on the higher luminance side than the shoulder point and an anchor point on the lower luminance side than the toe point and so forth.

The metadata analysis section 101A outputs information representative of a result of the analysis of the game metadata to the signal processing section 103. Luminance adjustment by the signal processing section 103 is performed on the basis of the result of the analysis of the game metadata by the metadata analysis section 101A.

The external inputting section 102 is an interface to an external output such as the HDMI. The external inputting section 102 communicates with the game machine 1 through an HDMI cable and receives and outputs data of respective pictures of HDR video transmitted thereto from the game machine 1 to the signal processing section 103. Further, the external inputting section 102 receives game metadata transmitted thereto together with the respective pictures of the HDR video to which the game metadata is added and outputs the game metadata to the controller 101.

The signal processing section 103 performs processing of the HDR video supplied from the external inputting section 102 and causes the display 104 to display an image of the game. The signal processing section 103 performs luminance adjustment of the HDR video under the control of the controller 101.

The signal processing section 103 also performs a process for causing the display 104 to display an image of a broadcasting program on the basis of data supplied from the decoding processing section 106.

The display 104 is a display device such as an LCD (Liquid Crystal Display) or an organic EL (Electro Luminescence) display. The display 104 displays an image of a game or an image of a broadcasting program on the basis of the video signal supplied from the signal processing section 103.

The broadcasting reception section 105 extracts a broadcasting signal of a predetermined channel from a signal supplied from an antenna and outputs the broadcasting signal to the decoding processing section 106. The extraction of the broadcasting signal by the broadcasting reception section 105 is performed under the control of the controller 101.

The decoding processing section 106 performs processes such as decoding for the broadcasting signal supplied from the broadcasting reception section 105 and outputs video data of a broadcasting program to the signal processing section 103.

The communication section 107 is an interface such as a wireless LAN and a wired LAN. The communication section 107 performs communication with a server through the Internet.

### <Operation of Game Machine>

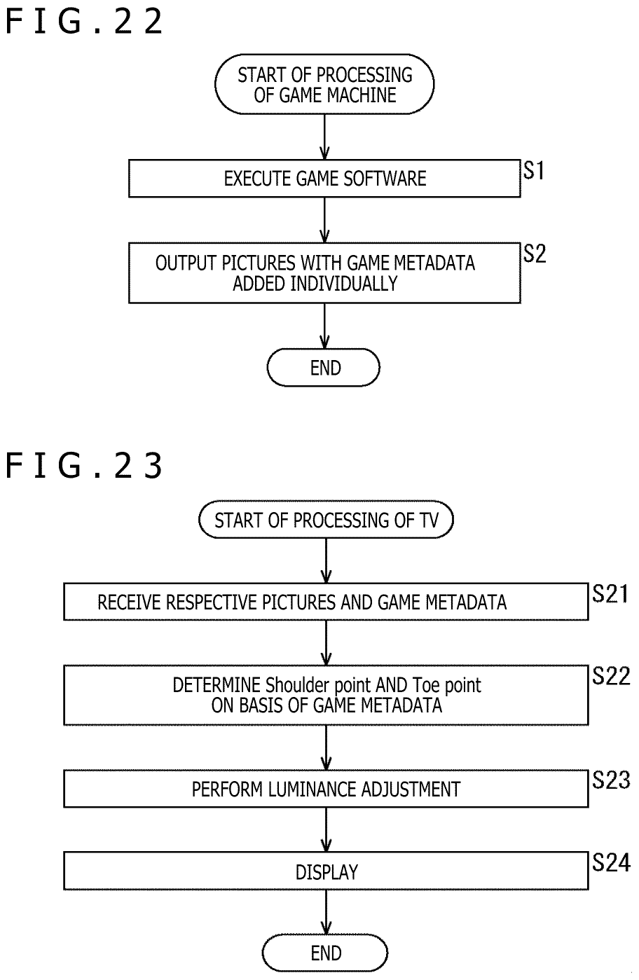

Here, processing of the game machine 1 is described with reference to a flow chart of FIG. 22.

In step S, the game software execution section 71 of the controller 51 executes game software to generate respective pictures of HDR video configuring images of a game and game metadata. By executing the game software, such various kinds of game metadata as described hereinabove with reference to FIG. 8 and so forth are generated.

In step S2, the output controlling section 72 adds the game metadata generated by the game software execution section 71 to the respective pictures of the HDR video configuring images of the game and causes the external outputting section 58 to output the respective pictures to which the metadata is added.

The processes described above are performed repeatedly while the user continues to play the game.

### <Operation of TV>

Now, processing of the TV 2 is described with reference to a flow chart of FIG. 23.

In step S21, the external inputting section 102 of the TV 2 receives data of respective pictures of HDR video transmitted from the game machine 1 and game metadata transmitted together with and added to the data.

In step S22, the metadata analysis section 101A of the controller 101 analyzes the game metadata transmitted from the game machine 1 to specify a shoulder point and a toe point.

For example, in the case where game metadata including the descriptions of FIG. 8 is transmitted to the TV 2, the metadata analysis section 101A specifies a shoulder point on the basis of the description of Shoulder point and specifies a toe point on the basis of the description of Toe point. Information representative of a result of analysis of the game metadata is supplied from the metadata analysis section 101A to the signal processing section 103.

In step S23, the signal processing section 103 performs luminance adjustment of the HDR video on the basis of the result of analysis of the game metadata. For example, in regard to a luminance from the toe point to the shoulder point, the luminance adjustment of the HDR video is performed such that the luminance is outputted as it is as a luminance.

In step S24, the signal processing section 103 causes the display 104 to display the HDR video for which the luminance adjustment has been performed. The display of the HDR video configuring images of the game is continued while the game software is executed by the game machine 1.

By the processes described above, the game machine 1 can cause luminance adjustment on the TV 2 to be performed in an appropriate form in accordance with a method designated by the creator of the game software.

### <<Generation Side of Game Software>>

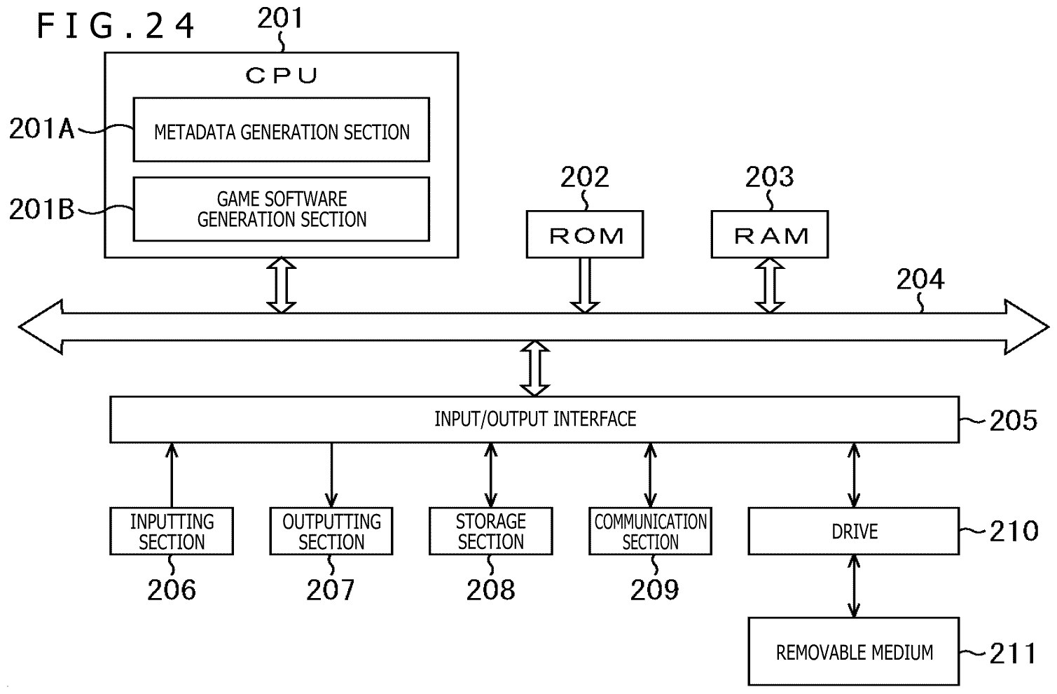

FIG. 24 is a block diagram depicting an example of a configuration of a computer used for generation of such game software as described above.

A CPU 201, a ROM 202, and a RAM 203 are connected to each other by a bus 204. In the CPU 201, a metadata generation section 201A and a game software generation section 201B are implemented by execution of a predetermined program.

The metadata generation section 201A generates game metadata described hereinabove with reference to FIG. 8 and so forth, for example, according to an operation by a creator.

The game software generation section 201B generates game software to be executed by the game machine 1. The game software generated by the game software generation section 201B includes a game program for progressing a game, game data to be utilized by the game program, and information to be used for generation of images and sound of the game. The information to be used for generation of images of the game also includes game metadata generated by the metadata generation section 201A.

Further, an input/output interface 205 is connected to the bus 204. An inputting section 206, an outputting section 207, a storage section 208, a communication section 209, and a drive 210 are connected to the input/output interface 205. A removable medium 211 is mounted on the drive 210.

The inputting section 206 includes a keyboard, a mouse and so forth and is operated by the creator of the game software.

The outputting section 207 includes a display, a speaker and so forth. The display configuring the outputting section 207 is used, for example, as a mastering display.

The storage section 208 includes a hard disk, a nonvolatile memory or the like. Various kinds of data of the game software generated by the game software generation section 201B and so forth are stored into the storage section 208.

The communication section 209 includes a network interface or the like.

The drive 210 controls reading out of data recorded in the removable medium 211 including an optical disk, a semiconductor memory or the like and writing of data into the removable medium 211.

In the computer configured in such a manner as described above, the CPU 201 loads a program stored, for example, in the storage section 208 into the RAM 203 and executes the program to perform various processes such as a generation process of game software.

In such a manner, the computer of FIG. 24 functions as an information processing apparatus that generates game software.

### Other Examples

Although the pieces of metadata including the descriptions described hereinabove with reference to FIG. 8 and so forth are pieces of metadata for an image of a game, they may otherwise be used for luminance adjustment of various kinds of video data of a movie, a still picture and so forth.

Although the foregoing description is directed to a case in which the luminance of HDR video transmitted from the game machine 1 is adjusted, game software transmitted from a server through the Internet 12 may be executed on the TV 2. HDR video generated by execution of the game software is subjected to luminance adjustment on the basis of game metadata and displayed on the TV 2.

Although, in the example of FIG. 24, the metadata generation section 201A is implemented by a computer that generates game software, the metadata generation section 201A may otherwise be implemented by a computer that does not have the function of generating game software.

For example, a computer that configures a server that delivers such content as game software or movies can be configured such that the metadata generation section 201A that generates metadata including such various descriptions as described above is implemented. The metadata generation section 201A of the server thus generates metadata for a piece of content to be delivered and delivers the generated metadata together with the content.

This makes it possible for the server to allow an apparatus, which becomes a delivery destination, to appropriately perform luminance adjustment of the higher luminance side and the lower luminance side of a piece of content to be distributed through the Internet 12.

### Example of Program

The series of processes described above cannot only be executed by hardware and can also be executed by software. In the case where the series of processes is executed by software, a program that constructs the software is installed into a computer incorporated in hardware for exclusive use or a personal computer for universal use.

The program to be installed is recorded on and provided as a removable medium 211 depicted in FIG. 24, which includes an optical disk (CD-ROM (Compact Disc-Read Only Memory), a DVD (Digital Versatile Disc) or the like), a semiconductor memory or the like. The program may otherwise be provided through a wired or wireless transmission medium such as a local area network, the Internet, or a digital broadcasting. The program can be installed in the ROM 202 or the storage section 208 in advance.

The program to be executed by the computer may be a program by which processing is carried out in a time series in the order as described in the present specification or may be a program by which processing is performed in parallel or performed at necessary timings such as when the process is called.

It is to be noted that, in the present specification, the term system is used to signify an aggregation of a plurality of components (devices, modules (parts) and so forth) and it does not matter whether or not all components are accommodated in the same housing. Accordingly, plural apparatuses accommodated in separate housings and connected to each other through a network is a system, and also one apparatus in which a plurality of modules is accommodated in a single housing is a system.

The effects described in the present specification are exemplary to the last, and other effects may be applicable.

The embodiment of the present technology is not limited to the embodiment described above and allows various alterations without departing from the subject matter of the present technology.

For example, the present technology can be configured for cloud computing by which one function is processed plural apparatuses that share and cooperate to perform processing through a network.

Further, each of the steps of the flow charts described hereinabove can be executed by a single apparatus or can be shared and executed by plural apparatuses.

Further, in the case where a plurality of processes is included in one step, the plurality of processes included in the one step can be executed by one apparatus or can be shared and executed by plural apparatuses.

### Examples of Combination of Configurations

It is also possible for the present technology to take such a configuration as described below.

(1)

An information processing apparatus, including:

a metadata generation section configured to generate metadata representative of a feature of a luminance of each picture, the metadata including information representative of a first knee point and information representative of a second knee point on a lower luminance side than the first knee point; and

a software generation section configured to generate software including the metadata to be used in luminance adjustment of the picture.

(2)

The information processing apparatus according to (1) above, in which

the metadata generation section generates the metadata that describes two pieces of point information each representative of the first knee point and the second knee point.

(3)

The information processing apparatus according to (1) or (2) above, in which

the metadata generation section generates the metadata that further includes information of a first anchor point representative of an input/output characteristic of a luminance in a luminance range higher than a luminance indicated by the first knee point and information of a second anchor point representative of an input/output characteristic of a luminance in a luminance range lower than a luminance indicated by the second knee point.

(4)

The information processing apparatus according to (3) above, in which

the metadata generation unit generates the metadata that individually describes Bezier curve anchors as the information of the first anchor point and Bezier curve anchors as information of the second anchor point.

(5)

The information processing apparatus according to (3) above, in which

the metadata generation section generates the metadata that describes one piece of Bezier curve anchors representative of the first anchor point and the second anchor point.

(6)

The information processing apparatus according to any one of (1) to (5) above, in which

one knee point of either the first knee point or the second knee point is represented by Knee point of Dynamic metadata prescribed by SMPTE2094-40 and the other knee point is represented using Distribution max rgb percentages and Distribution max rgb percentiles of the Dynamic metadata.

(7)

An information processing method by an information processing apparatus, including:

generating metadata representative of a feature of a luminance of each picture, the metadata including information representative of a first knee point and information representative of a second knee point on a lower luminance side than the first knee point; and

generating software including the metadata to be used in luminance adjustment of the picture.

(8)

A program for causing a computer to execute the processes of:

generating metadata representative of a feature of a luminance of each picture, the metadata including information representative of a first knee point and information representative of a second knee point on a lower luminance side than the first knee point; and

generating software including the metadata to be used in luminance adjustment of the picture.

(9)

An image processing apparatus, including:

a communication section configured to receive pictures outputted from an information processing apparatus and metadata added to each of the pictures and representative of a feature of a luminance, the metadata including information representative of a first knee point and information representative of a second knee point on a lower luminance side than the first knee point; and

a signal processing section configured to adjust the luminance of the picture on the basis of the metadata.

(10)

The image processing apparatus according to (9) above, in which

the first knee point and the second knee point are individually represented by two pieces of point information described in the metadata.

(11)

The image processing apparatus according to (9) or (10) above, in which

the metadata further includes information of a first anchor point representative of an input/output characteristic of a luminance in a luminance range higher than a luminance indicated by the first knee point and information of a second anchor point representative of an input/output characteristic of a luminance in a luminance range lower than a luminance indicated by the second knee point.

(12)

The image processing apparatus according to (11) above, in which

the metadata has individually described Bezier curve anchors as the information of the first anchor point and Bezier curve anchors as information of the second anchor point in the metadata.

(13)

The image processing apparatus according to (11) above, in which

the metadata describes one piece of Bezier curve anchors representative of the first anchor point and the second anchor point.

(14)

The image processing apparatus according to any one of (9) to (13) above, in which

one knee point of either the first knee point or the second knee point is represented by Knee point of Dynamic metadata prescribed by SMPTE2094-40 and the other knee point is represented using Distribution max rgb percentages and Distribution max rgb percentiles of the Dynamic metadata.

(15)

An image processing method by an image processing apparatus, including:

receiving pictures outputted from an information processing apparatus and metadata added to each of the pictures and representative of a feature of a luminance, the metadata including information representative of a first knee point and information representative of a second knee point on a lower luminance side than the first knee point; and

adjusting the luminance of the picture on the basis of the metadata.

(16)

A program for causing a computer to execute the processes of:

receiving pictures outputted from an information processing apparatus and metadata added to each of the pictures and representative of a feature of a luminance, the metadata including information representative of a first knee point and information representative of a second knee point on a lower luminance side than the first knee point; and

adjusting the luminance of the picture on the basis of the metadata.

(17)

An information processing apparatus, including:

an output controlling section configured to add, to each of pictures for which luminance adjustment is to be performed by a display apparatus, metadata representative of a feature of a luminance and including information representative of a first knee point and information representative of a second knee point on a lower luminance side than the first knee point, and output each of the pictures to which the metadata is added to the display apparatus.

(18)

An information processing method by an information processing apparatus, including:

adding, to each of pictures for which luminance adjustment is to be performed by a display apparatus, metadata representative of a feature of a luminance and including information representative of a first knee point and information representative of a second knee point on a lower luminance side than the first knee point; and

outputting each of the pictures to which the metadata is added to the display apparatus.

(19)

A program for causing a computer to execute the processes of:

adding, to each of pictures for which luminance adjustment is to be performed by a display apparatus, metadata representative of a feature of a luminance and including information representative of a first knee point and information representative of a second knee point on a lower luminance side than the first knee point; and

outputting each of the pictures to which the metadata is added to the display apparatus.

### REFERENCE SIGNS LIST

1 Game machine, 2 TV, 51 Controller, 52 Disk drive, 53 Memory, 54 Local storage, 55 Communication section, 56 Decoding processing section, 57 Operation inputting section, 58 External outputting section, 71 Game software execution section, 72 Output controlling section, 101A Metadata analysis section, 201A Metadata generation section, 201B Game software generation section

1. An information processing apparatus, comprising:
a metadata generation section configured to generate metadata representative of a feature of a luminance of each picture, the metadata including information representative of a first knee point and information representative of a second knee point on a lower luminance side than the first knee point; and
a software generation section configured to generate software including the metadata to be used in luminance adjustment of the picture.

2. The information processing apparatus according to claim 1, wherein
the metadata generation section generates the metadata that describes two pieces of point information each representative of the first knee point and the second knee point.

3. The information processing apparatus according to claim 1, wherein
the metadata generation section generates the metadata that further includes information of a first anchor point representative of an input/output characteristic of a luminance in a luminance range higher than a luminance indicated by the first knee point and information of a second anchor point representative of an input/output characteristic of a luminance in a luminance range lower than a luminance indicated by the second knee point.

4. The information processing apparatus according to claim 3, wherein
the metadata generation unit generates the metadata that individually describes Bezier curve anchors as the information of the first anchor point and Bezier curve anchors as information of the second anchor point.

5. The information processing apparatus according to claim 3, wherein
the metadata generation section generates the metadata that describes one piece of Bezier curve anchors representative of the first anchor point and the second anchor point.

6. The information processing apparatus according to claim 1, wherein
one knee point of either the first knee point or the second knee point is represented by Knee point of Dynamic metadata prescribed by SMPTE2094-40 and the other knee point is represented using Distribution max rgb percentages and Distribution max rgb percentiles of the Dynamic metadata.

7. An information processing method by an information processing apparatus, comprising:
generating metadata representative of a feature of a luminance of each picture, the metadata including information representative of a first knee point and information representative of a second knee point on a lower luminance side than the first knee point; and
generating software including the metadata to be used in luminance adjustment of the picture.

8. A program for causing a computer to execute the processes of:
generating metadata representative of a feature of a luminance of each picture, the metadata including information representative of a first knee point and information representative of a second knee point on a lower luminance side than the first knee point; and
generating software including the metadata to be used in luminance adjustment of the picture.

9. An image processing apparatus, comprising:
a communication section configured to receive pictures outputted from an information processing apparatus and metadata added to each of the pictures and representative of a feature of a luminance, the metadata including information representative of a first knee point and information representative of a second knee point on a lower luminance side than the first knee point; and
a signal processing section configured to adjust the luminance of the picture on a basis of the metadata.

10. The image processing apparatus according to claim 9, wherein
the first knee point and the second knee point are individually represented by two pieces of point information described in the metadata.

11. The image processing apparatus according to claim 9, wherein
the metadata further includes information of a first anchor point representative of an input/output characteristic of a luminance in a luminance range higher than a luminance indicated by the first knee point and information of a second anchor point representative of an input/output characteristic of a luminance in a luminance range lower than a luminance indicated by the second knee point.

12. The image processing apparatus according to claim 11, wherein
the metadata has individually described Bezier curve anchors as the information of the first anchor point and Bezier curve anchors as information of the second anchor point in the metadata.

13. The image processing apparatus according to claim 11, wherein
the metadata describes one piece of Bezier curve anchors representative of the first anchor point and the second anchor point.

14. The image processing apparatus according to claim 9, wherein
one knee point of either the first knee point or the second knee point is represented by Knee point of Dynamic metadata prescribed by SMPTE2094-40 and the other knee point is represented using Distribution max rgb percentages and Distribution max rgb percentiles of the Dynamic metadata.

15. An image processing method by an image processing apparatus, comprising:
receiving pictures outputted from an information processing apparatus and metadata added to each of the pictures and representative of a feature of a luminance, the metadata including information representative of a first knee point and information representative of a second knee point on a lower luminance side than the first knee point; and
adjusting the luminance of the picture on a basis of the metadata.

16. A program for causing a computer to execute the processes of:
receiving pictures outputted from an information processing apparatus and metadata added to each of the pictures and representative of a feature of a luminance, the metadata including information representative of a first knee point and information representative of a second knee point on a lower luminance side than the first knee point; and
adjusting the luminance of the picture on a basis of the metadata.

17. An information processing apparatus, comprising:
an output controlling section configured to add, to each of pictures for which luminance adjustment is to be performed by a display apparatus, metadata representative of a feature of a luminance and including information representative of a first knee point and information representative of a second knee point on a lower luminance side than the first knee point, and output each of the pictures to which the metadata is added to the display apparatus.

18. An information processing method by an information processing apparatus, comprising:
adding, to each of pictures for which luminance adjustment is to be performed by a display apparatus, metadata representative of a feature of a luminance and including information representative of a first knee point and information representative of a second knee point on a lower luminance side than the first knee point; and
outputting each of the pictures to which the metadata is added to the display apparatus.

19. A program for causing a computer to execute the processes of:
adding, to each of pictures for which luminance adjustment is to be performed by a display apparatus, metadata representative of a feature of a luminance and including information representative of a first knee point and information representative of a second knee point on a lower luminance side than the first knee point; and
outputting each of the pictures to which the metadata is added to the display apparatus.
